(19) United States
(12) Patent Application Publication
(10) Pub. No.: US 2023/0356649 A1
(43) Pub. Date: Nov. 9, 2023

(54) VEHICLE HEADLIGHT SYSTEM

(71) Applicant: LAZER LAMPS LTD, Harlow Essex (GB)

(72) Inventor: Ben Charles RUSSELL-SMITH, Harlow (GB)

(21) Appl. No.: 18/025,736

(22) PCT Filed: Sep. 9, 2021
(86) PCT No.: PCT/EP2021/074873

§ 371 Date: Mar. 10, 2023

(30) Foreign Application Priority Data
Sep. 10, 2020 (GB) 2014267.5

(51) Int. Cl. B60Q 1/14; B60Q 1/00; F21S 41/40; F21S 41/151; F21S 41/143; H05B 47/11; F21S 41/147; F21S 41/148; F21S 41/663

(52) U.S. Cl. CPC B60Q 1/1415; B60Q 1/0023; F21S 41/40; F21S 41/151; F21S 41/143; H05B 47/11; F21S 41/147; F21S 41/148; F21S 41/663; B60Q 2300/054

(57) ABSTRACT

The invention consists of vehicle headlight system 1 comprising light sources 5 which shine light outwards from the vehicle and photosensing devices 9 which sense light shining towards the vehicle. The photosensing devices 9 are located adjacent to light sources 5 and a shield reduces detection of light spill. In a high-beam mode, a controller causes the light sources 5 to shine light at a high-beam brightness level. In a low-beam mode, the controller receives signals from the photosensing devices 9, uses the signals to determine a position of an oncoming vehicle and causes light sources 5 shining light to the position to reduce their brightness to a low-beam brightness level or to zero. As the position of the oncoming vehicle changes, the controller continuously receives signals from the photosensing devices 9, uses the signals to determine a new position of the oncoming vehicle and causes light sources 5 shining light to the new position, to reduce their brightness.

### CROSS-REFERENCE TO RELATED APPLICATIONS

This application is a U.S. National Phase application submitted under 35 U.S.C. § 371 of Patent Cooperation Treaty application serial no. PCT/EP2021/074873, filed Sep. 9, 2021, and entitled VEHICLE HEADLIGHT SYSTEM, which application claims priority to European Patent Application No. 2014267.5, filed Sep. 10, 2020, entitled VEHICLE HEADLIGHT SYSTEM. Patent Cooperation Treaty application serial no. PCT/EP2021/074873, published as WO 2022/053590 A1, and European patent application serial no. 2014267.5, are incorporated herein by reference.

### TECHNICAL FIELD

The invention relates to a vehicle headlight system particularly for detecting light from oncoming vehicles and providing intelligent low beam illumination of the oncoming vehicle.

### BACKGROUND

It is well known that modern vehicles may comprise matrix-type headlights, comprising a plurality of light sources, wherein the illumination from the light sources shine onto different zones of the road. Generally, a camera-based light sensor system is installed internally to the vehicle, to the centre rear-view mirror, facing forwards which enables detection of vehicles driving on the road ahead. When a vehicle is detected within a certain zone, light from the light sources shining to that zone is diminished, to prevent glare and discomfort to the other road user. Where several vehicles are detected in several different zones, the light which is being directed to those zones is diminished and the other zones remain fully illuminated. As the position of the vehicle on the road ahead changes, the light zone in which the vehicle is detected changes and the intensity of light shining to a zone is intelligently attenuated.

When the vehicle is driving at night the headlights fitted at time of vehicle manufacture, will have different modes to provide forward illumination of the roadway. All vehicles have low-beam and high-beam functions. The headlights may be permanently in a high beam state and when the sensor system within the vehicle senses an oncoming car in a particular zone, the low-beam function is selected and a dark area is formed around the oncoming car so as to reduce dazzle of the car.

### SUMMARY

According to the invention there is provided a vehicle headlight system for a vehicle, operable in a high-beam mode and in a low-beam mode, comprising:
a plurality of light sources arranged to shine light outwards from a front of the vehicle,
a control circuit connected to the plurality of light sources and configured to control operation of the light sources in the high-beam mode and the low-beam mode,
a plurality of photosensing devices configured to sense light shining towards the front of the vehicle and to produce a plurality of signals indicating light intensities from a plurality of positions in front of the vehicle, the plurality of photosensing devices being located adjacent to at least some of the plurality of light sources,
a shield configured to reduce detection of light spill from the plurality of light sources by the plurality of photosensing devices, and
a controller connected to the control circuit and the plurality of photosensing devices and configured to:
in the high-beam mode, send a signal to the control circuit to cause the control circuit to operate at least some of the plurality of light sources to shine light at a high-beam brightness level, and
in the low-beam mode, receive the plurality of signals indicating light intensities from a plurality of positions in front of the vehicle, use the signals to determine an oncoming vehicle in one or more of the plurality of positions and send a signal to the control circuit to cause the control circuit to operate one or more of the plurality of light sources shining light towards the oncoming vehicle to reduce brightness of the one or more light sources.

The brightness of the one or more light sources may be reduced to a low-beam brightness level. The brightness of the one or more light sources may be reduced to zero.

The plurality of light sources may comprise a plurality of light emitting diodes (LEDs). The plurality of light sources may comprise a plurality of LASERs.

The plurality of light sources may be arranged in one or more substantially rectangular arrays. The plurality of light sources may be arranged in one or more substantially linear arrays.

The vehicle headlight system may comprise a light source optical system placed in proximity to the plurality of light sources to shine light from the plurality of light sources onto a roadway in front of the vehicle. The light source optical system may shine light from the plurality of light sources onto a roadway in front of the vehicle at an angle of approximately 25 degrees around a centreline of the roadway in front of the vehicle.

The light source optical system may comprise one optical element. The light source optical system may comprise a plurality of optical elements. The or each optical element may comprise any of reflective mirrors, optical lenses. The plurality of optical elements may be arranged in one or more substantially rectangular arrays. The plurality of optical elements may be arranged in one or more substantially linear arrays.

The light source optical system may comprise an optical element placed in proximity to each of a plurality of subsets of the plurality of light sources. Each optical element placed in proximity to a subset of the plurality of light sources may shine light from one light source of the subset of light sources onto the roadway in front of the vehicle to illuminate a specified position of the roadway in front of the vehicle.

The plurality of light sources and the light source optical system may be arranged to shine a total light intensity onto the roadway in front of the vehicle which does not exceed a maximum allowed light intensity. The maximum allowed light intensity may differ according to different regulations in different countries.

The control circuit connected to the plurality of light sources and configured to control selective operation of the light sources may individually control operation of the light sources to control brightness of each of the light sources independently.

The plurality of photosensing devices may continuously sense light shining towards the front of the vehicle.

The plurality of photosensing devices may comprise a plurality of photosensors. The plurality of photosensors may be arranged in one or more substantially rectangular arrays. The plurality of photosensors may be arranged in one or more substantially linear arrays. The plurality of photosensors may comprise a plurality of photodiodes.

The plurality of photosensing devices may comprise a plurality of photosensing cells of a multi-cell photosensor. The plurality of photosensing cells may be arranged in one or more substantially rectangular arrays. The plurality of photosensing cells may be arranged in one or more substantially linear arrays.

The vehicle headlight system may comprise a light sensor optical system placed in front of the plurality of photosensing devices to direct light shining towards the front of the vehicle onto the plurality of photosensing devices. The light sensor optical system may direct light shining from an angle of approximately 20 degrees each side of a centreline of a roadway in front of the vehicle onto the plurality of photosensing devices. The light sensor optical system may comprise one or more optical elements placed in front of the plurality of photosensing devices. The one or more optical elements may comprise any of reflective mirrors, optical lenses.

The light sensor optical system may comprise an optical element placed in front of each of a plurality of subsets of the plurality of photosensing devices. The optical element placed in front of each of the plurality of subsets of the plurality of photosensing devices may direct light shining from a moving light source in front of the vehicle to illuminate successive photosensing devices of the subset of photosensing devices. The optical element placed in front of each of the plurality of subsets of the plurality of photosensing devices may focus light shining from a moving light source in front of the vehicle onto successive photosensing devices of the subset of photosensing devices causing the photosensing devices to successively register a higher than normal light intensity as the light source moves in front of the vehicle.

The light sensor optical system may comprise one optical element placed in front of the plurality of photosensing devices. The optical element placed in front of the plurality of photosensing devices may direct light shining from a moving light source in front of the vehicle to illuminate successive photosensing devices. The optical element placed in front of the plurality of photosensing devices may focus light shining from a moving light source in front of the vehicle to illuminate successive photosensing devices causing the photosensing devices to successively register a higher than normal light intensity as the light source moves in front of the vehicle.

The plurality of photosensing devices may be located adjacent to and between a first upper subset of the plurality of light sources and a second lower subset of the plurality of light sources. The plurality of photosensing devices may be located adjacent to and beneath a subset of the plurality of light sources. The plurality of photosensing devices may be located adjacent to and between a first left-hand light source and a second righthand light source of the plurality of light sources.

The shield configured to reduce detection of light spill from the plurality of light sources by the plurality of photosensing devices may comprise a barrier placed between the plurality of light sources and the plurality of photosensing devices to reduce light spill from the plurality of light sources entering the plurality of photosensing devices. The barrier may have additional functionality such as being a holder for the plurality of photosensing devices.

The shield configured to reduce detection of light spill from the plurality of light sources by the plurality of photosensing devices may comprise software of the system which enables the plurality of photosensing devices to filter out light spill from the plurality of light sources.

On entering the low-beam mode, the controller may send a signal to the control circuit to cause the control circuit to operate at least some of the plurality of light sources to reduce brightness of the light sources to the low-beam brightness level. The low-beam brightness level may be approximately 30% of the high-beam brightness level.

The controller may wait for a pause period of time. The pause period may be approximately 100 ms. For each photosensing device, the controller may use one or more signals received from the photosensing device to perform a self-calibration function to determine a baseline light intensity recorded by the photosensing device. For each photosensing device, the self-calibration function may comprise using a plurality of signals received from the device at spaced intervals to determine the baseline light intensity recorded by the photosensing device.

The baseline light intensity recorded by of each of the plurality of photosensing devices may be used to establish a baseline road light intensity shining from a roadway in front of the vehicle. An increased light intensity caused by an oncoming vehicle can then easily be distinguished from the baseline road light intensity. This improves the accuracy of the sensing of an oncoming vehicle and reduces errors caused by, for example, roadways which may have higher reflectivity from one part of the roadway to another or dirt obscuring one or more of the photosensing devices or moisture causing reflections onto one or more of the photosensing devices.

For each photosensing device, the controller may compare a light intensity of at least one signal from the photosensing device to the baseline light intensity recorded by the device. When the light intensity of at least one signal from a photosensing device is greater than the baseline light intensity, the controller may determine that the photosensing device is sensing a light zone of an oncoming vehicle in front of the vehicle. When the light intensity of at least one signal from a photosensing device is greater than the baseline light intensity by a first pre-determined amount, the controller may determine that the photosensing device is sensing a light zone of an oncoming vehicle in front of the vehicle.

The controller may use the signal from the photosensing device to determine the identity of the photosensing device. The controller may use the identity of the photosensing device to determine identities of one or more corresponding light sources which shine light to the light zone of the oncoming vehicle in front of the vehicle.

The controller may send a signal to the control circuit to cause the control circuit to operate the one or more corresponding light sources shining light to the light zone of the oncoming vehicle in front of the vehicle to reduce brightness of the one or more corresponding light sources. The brightness of the one or more light sources may be reduced to the low-beam brightness level. The brightness of the one or more light sources may be reduced to zero.

When a light intensity of at least one signal from successive photosensing devices is greater than the baseline light intensities by the first pre-determined amount, the controller may determine that the photosensing devices are sensing a moving light zone of an oncoming vehicle in front of the vehicle.

The controller may send a signal to the control circuit to cause the control circuit to successively operate one or more corresponding light sources shining light to the moving light zone of the oncoming vehicle on the roadway in front of the vehicle to reduce brightness of the one or more corresponding light sources. The brightness of the one or more corresponding light sources may be reduced to the low-beam brightness level. The brightness of the one or more corresponding light sources may be reduced to zero. The control circuit may also successively operate the one or more corresponding light sources not shining light to the moving light zone of the oncoming vehicle in front of the vehicle to have a brightness level equal to that immediately after the vehicle high-beam mode is switched off. This brightness level may be approximately 30% of the high-beam brightness level.

When a light intensity of at least one signal from a photosensing device is greater than the baseline light intensity recorded by the device by a second pre-determined amount, the controller may determine that the photosensing device is sensing a light zone of a road sign in front of the vehicle. The controller may send a signal to the control circuit to cause the control circuit to operate the one or more corresponding light sources shining light to the light zone of the road sign in front of the vehicle to reduce brightness of the one or more corresponding light sources. This has the additional benefit of reducing glare from road signs.

The vehicle headlight system may comprise a housing containing at least the plurality of light sources, the light source optical system, the plurality of photosensing devices, the light sensor optical system and the shield. The housing may further contain the control circuit and the controller. The control circuit and the controller may be placed outside the housing.

The housing may comprise a cover located in front of the plurality of light sources and the plurality of photosensing devices. The cover may protect at least the plurality of light sources and the plurality of photosensing devices from environmental conditions. The cover may comprise a lens. An outer lens may be situated between the cover and the plurality of light sources and the plurality of photosensing devices.

The vehicle headlight system may comprise a switch located within the vehicle which enables and disables the system.

The vehicle headlight system may comprise an electrical connection connecting the system to the vehicle by which power is supplied to the system from the vehicle.

The vehicle headlight system may comprise a system installed in a vehicle on manufacture of the vehicle. The vehicle headlight system may be installed in a vehicle comprising any of a passenger car, a heavy goods vehicle, a light commercial vehicle.

The vehicle headlight system may comprise an auxiliary vehicle headlight system adapted for attachment to a vehicle after manufacture of the vehicle.

In a wide variety of countries, but especially those where the nights are longer, drivers choose to fit auxiliary headlight systems to vehicles so they can improve their safety during night driving. In the high-beam mode, the existing vehicle headlight system, installed on manufacture of the vehicle, and the auxiliary headlight system are both activated and provide light on the roadway in front of the vehicle. In the low-beam mode, light sources of the existing headlight system are switched to low-beam brightness and light sources of the auxiliary headlight system are switched off. This means that the driver's eyes need to adjust to a greatly reduced level of brightness on the roadway in front of the vehicle.

In the auxiliary vehicle headlight system of the invention, in the low-beam mode, light sources of the auxiliary vehicle headlight system in a light zone from an oncoming vehicle are selectively operated to reduce their brightness to a low-beam brightness level or to zero. The remaining light sources of the auxiliary vehicle headlight system are operated at a brightness of approximately 30% of the high-beam brightness level, thus increasing the level of brightness on the remaining roadway in front of the vehicle. The auxiliary vehicle headlight system provides a low-beam assist function to the existing vehicle headlight system.

The auxiliary vehicle headlight system may comprise a switch for deactivation and activation of the system. The switch may be located inside the vehicle. This gives the driver of the vehicle full control of whether to activate or deactivate the low beam assist function, so it may be operated safely. This may be particularly pertinent in the event that the lens of the auxiliary headlight system is dirty such that the system may not correctly sense light illumination in the front of the vehicle.

Positioning of the plurality of photosensing devices adjacent to at least some of the plurality of light sources is particularly advantageous for the auxiliary vehicle headlight system. Such positioning ensures alignment of the photosensing devices and the light sources in the same direction. Additionally, if the auxiliary vehicle headlight system is knocked out of position on the vehicle, the photosensing devices and the light sources are equally knocked out of position and can still operate together.

The auxiliary vehicle headlight system may comprise a light bar or a round lamp.

The auxiliary vehicle headlight system may be fitted to a vehicle comprising any of a passenger car, a heavy goods vehicle, a light commercial vehicle.

### BRIEF DESCRIPTION OF THE DRAWINGS

Embodiments of the invention will now be described by way of example only with reference to the accompanying drawings, in which:

FIG. 1 is a front view of a first embodiment of a vehicle headlight system according to the invention;

FIG. 2 is a cross sectional view of the vehicle headlight system of FIG. 1;

FIG. 3 is schematic representation of a plurality of photosensing devices and a light sensor optical system of the vehicle headlight system of FIG. 1;

FIG. 4 is a front view of a second embodiment of a vehicle headlight system according to the invention;

FIG. 5 is a cross sectional view of the vehicle headlight system of FIG. 4;

FIG. 6 is a close-up front view of the vehicle headlight system of FIG. 4;

FIG. 7 is schematic representation of a plurality of photosensing devices and a light sensor optical system of the vehicle headlight system of FIG. 4;

FIG. 8 is a front view of a third embodiment of a vehicle headlight system according to the invention;

FIG. 9 is a cross sectional view of the vehicle headlight system of FIG. 8;

FIG. 10 is a close-up front view of the vehicle headlight system of FIG. 8;

FIG. 11 is schematic representation of a plurality of photosensing devices and a light sensor optical system of the vehicle headlight system of FIG. 8, and

FIG. 12 is a front view of a fourth embodiment of a vehicle headlight system according to the invention.

### DETAILED DESCRIPTION

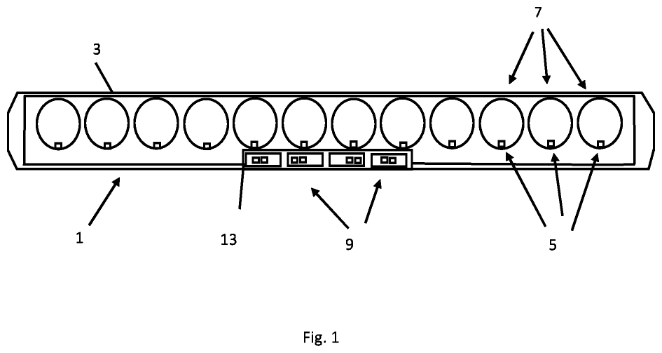

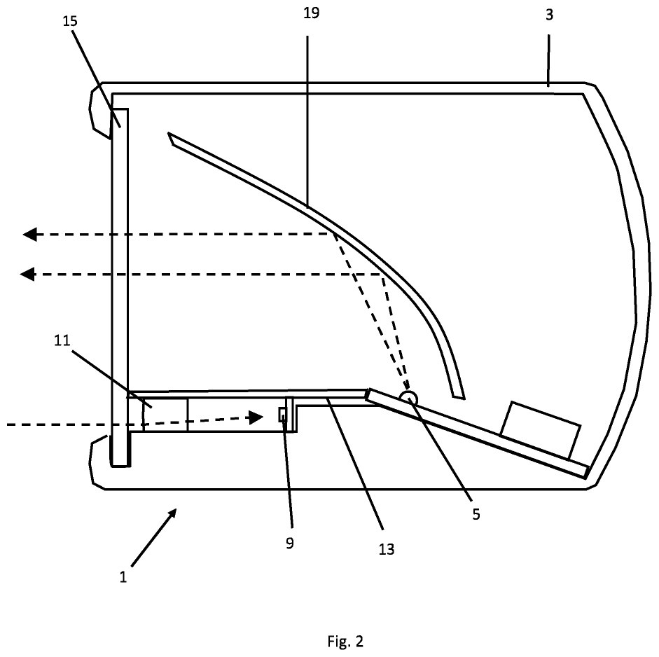

Referring to FIG. 1 and FIG. 2, a first embodiment of a vehicle headlight system 1 for a vehicle (not shown) comprises a housing 3, a plurality of light sources 5, a light source optical system 7, a control circuit (not shown), a plurality of photosensing devices 9, a light sensor optical system 11, a shield 13, a controller (not shown) and an outer lens 15.

The vehicle headlight system 1 may comprise a system installed in a vehicle on manufacture of the vehicle. The vehicle headlight system may be installed in a vehicle comprising any of a passenger car, a heavy goods vehicle, a light commercial vehicle. Alternatively, the vehicle headlight system 1 may comprise an auxiliary vehicle headlight system adapted for attachment to a vehicle after manufacture of the vehicle.

The housing 3 contains at least the plurality of light sources 5, the light source optical system 7, the plurality of photosensing devices 9, the light sensor optical system 11 and the shield 13. The housing 3 may further contain the control circuit and the controller, or these may be placed outside the housing 3.

The plurality of photosensing devices 9 are located adjacent to and beneath a subset of the plurality of light sources 5, as shown. The shield 13, configured to reduce detection of light spill from the plurality of light sources 5 by the plurality of photosensing devices 9, is formed from housing for the photosensing devices 9. This acts as a barrier to reduce light from plurality of light sources 5 entering the photosensing devices 9.

The vehicle headlight system 1 comprises an electrical connection (not shown) connecting the system 1 to the vehicle by which power is supplied to the system 1 from the vehicle. The vehicle headlight system 1 comprises a switch (not shown) located within the vehicle which enables and disables the system 1.

The plurality of light sources 5 are located within the housing 3, as shown, and arranged to shine light outwards from the front of the vehicle. The plurality of light sources 5 comprise any of a plurality of LEDs, a plurality of lasers provided on a printed circuit board.

The light source optical system 7 comprises twelve reflective mirrors 17 arranged in a substantially linear array. It will be appreciated that the light source optical system could instead comprise a plurality of optical lenses. Each reflective mirror 17 is placed in proximity to a subset of five light sources 5 and acts to shine light from one of the light sources 5 onto the roadway in front of the vehicle to illuminate a specified position of the roadway in front of the vehicle. Each of the subsets of five light sources 5 are arranged in an arcuate array.

The control circuit is connected to the plurality of light sources 5 and is configured to control selective operation of the light sources to control brightness of each light source, or a subset of the light sources, independently.

The plurality of photosensing devices 9 are located within the housing 3, as shown, and configured to sense light shining towards the front of the vehicle and to produce a plurality of signals comprising light intensities from a plurality of positions in front of the vehicle. In this embodiment, the plurality of photosensing devices 9 comprise a plurality of photodiodes each having 1 mm2 sensing portion.

Referring to FIGS. 1 to 3, the light sensor optical system 11 comprises four optical lenses 19 arranged in a substantially linear array. It will be appreciated that the light sensor optical system could instead comprise a plurality of optical reflectors. Each optical lens 19 is placed in front of a subset of two photosensing devices 9 to direct light shining towards the front of the vehicle onto the photosensing devices 9. Each photosensing device 9 of each subset is located away from the centreline of the optical lens 19. The eight photosensing devices 9 in the subsets are arranged in a substantially linear array.

The optical lenses 19 placed in front of the plurality of subsets of photosensing devices 9 are arranged in such a way to direct and focus light shining from a moving light source in front of the vehicle to illuminate successive photosensing devices 9. This causes successive photosensing devices 9 to register a higher than normal light intensity as the light source moves in front of the vehicle. As the light shining from the moving light source moves through a plurality of positions in front of the vehicle, only one photosensing device 9 will register a higher light intensity at each position.

The vehicle headlight system 1 operates in a high-beam mode and a low-beam mode. The controller is connected to the control circuit and the plurality of photosensing devices 9 and is configured in the high-beam mode to send a signal to the control circuit to cause the control circuit to operate at least some of the plurality of light sources 5 to shine light at a high-beam brightness level, and in the low-beam mode, receive the plurality of signals indicating light intensities from a plurality of positions in front of the vehicle from the plurality of photosensing devices 9, use the signals to determine an oncoming vehicle in one or more of the plurality of positions and send a signal to the control circuit to cause the control circuit to operate one or more of the plurality of light sources 5 shining light towards the oncoming vehicle to reduce brightness of the one or more light sources to the low-beam brightness level or to zero.

The controller comprises an intelligent control algorithm which takes inputs from the plurality of photosensing devices 9 and determines the correct zones to illuminate on the roadway by the plurality of light sources 5.

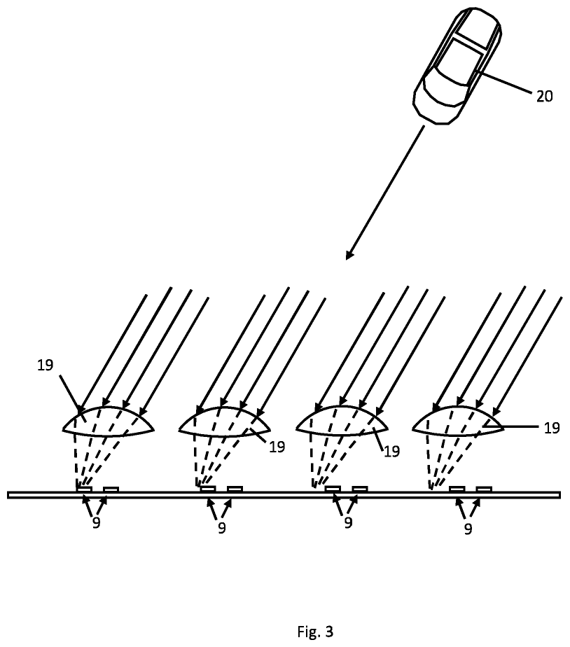

Referring to FIG. 3, light from a light zone produced by an oncoming vehicle 20 enters the light sensor optical system 11 at an angle which is dependent upon the position of the oncoming vehicle 20 on a roadway in front of the vehicle comprising the vehicle headlight system 1. As the oncoming vehicle 20 moves towards the vehicle, its position in front of the vehicle changes, i.e. over time, it takes up a plurality of positions in front of the vehicle.

On entering the low-beam mode, the controller sends a signal to the control circuit to cause the control circuit to operate at least some of the plurality of light sources 5 to reduce brightness of the light sources 5 to the low-beam brightness level. The low-beam brightness level may be approximately 30% of the high-beam brightness level.

The controller then waits for a pause period of time of approximately 100 ms. The controller then performs a self-calibration function to determine a baseline light intensity recorded by each of the plurality of photosensing devices 9. For each photosensing device 9, the self-calibration function comprises averaging light intensities of a plurality of signals received from the device 9 at spaced intervals to determine the baseline light intensity recorded by the photosensing device 9.

As the oncoming vehicle 20 moves towards the vehicle the light from the light zone produced by the oncoming vehicle 20 moves across the plurality of photosensing devices 9. The four optical lenses 19 of the light sensor optical system 11 and the plurality of photosensing devices 9 are arranged such that, one after the other, the light intensity of the signal from each photosensing device 9 is greater than the baseline light intensity recorded by the device. Only one of the photosensing devices 9 records a greater intensity at a time, in FIG. 3, the leftmost photosensing device 9 records a greater intensity.

For each photosensing device 9, the controller then compares the light intensity of at least one signal from the photosensing device 9 to the baseline light intensity recorded by the device 9. When the light intensity of the at least one signal from a photosensing device 9 is greater than the baseline light intensity recorded by the device 9, the controller determines that the photosensing device 9 is sensing a light zone of an oncoming vehicle in front of the vehicle.

The controller sends a signal to the control circuit to cause the control circuit to successively operate one or more corresponding light sources 5 shining light to the moving light zone of the oncoming vehicle in front of the vehicle to reduce brightness of the one or more corresponding light sources 5 to the low-beam brightness level or to zero and successively operate the one or more corresponding light sources 5 not shining light to the moving light zone of the oncoming vehicle in front of the vehicle to increase brightness of the one or more corresponding light sources 5 to 30% of the high-beam brightness level.

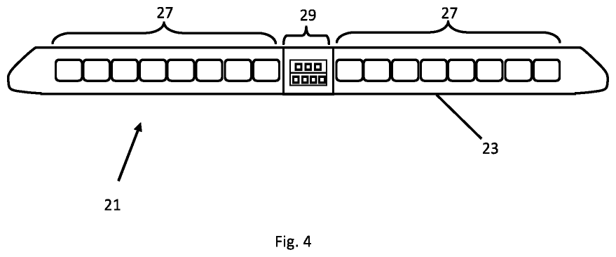

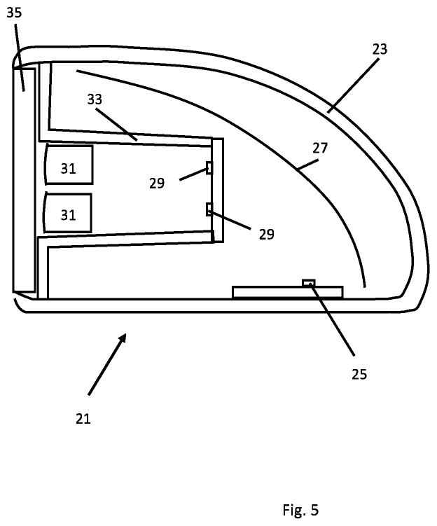

Referring to FIG. 4 and FIG. 5, a second embodiment of a vehicle headlight system 21 for a vehicle (not shown) comprises a housing 23, a plurality of light sources 25, a light source optical system 27, a control circuit (not shown), a plurality of photosensing devices 29, a light sensor optical system 31, a shield 33, a controller (not shown) and a cover 35.

The vehicle headlight system 21 may comprise a system installed in a vehicle on manufacture of the vehicle. The vehicle headlight system may be installed in a vehicle comprising any of a passenger car, a heavy goods vehicle, a light commercial vehicle. Alternatively, the vehicle headlight system 21 may comprise an auxiliary vehicle headlight system adapted for attachment to a vehicle after manufacture of the vehicle.

The housing 23 contains at least the plurality of light sources 25, the light source optical system 27, the plurality of photosensing devices 29, the light sensor optical system 31 and the shield 33. The housing 23 may further contain the control circuit and the controller, or these may be placed outside the housing 23. The housing 23 comprises a substantially transparent cover 35, which is an outer lens, located in front of the plurality of light sources 25 and the plurality of photosensing devices 29 to protect them from environmental conditions.

The plurality of photosensing devices 29 are located adjacent to and between a first left-hand light source and a second righthand light source of the plurality of light sources 25, as shown. The shield 33, configured to reduce detection of light spill from the plurality of light sources 25 by the plurality of photosensing devices 29, is formed from housing for the photosensing devices 29. This acts as a barrier to reduce light from plurality of light sources 25 entering the photosensing devices 29.

The vehicle headlight system 21 comprises an electrical connection (not shown) connecting the system 21 to the vehicle by which power is supplied to the system 1 from the vehicle. The vehicle headlight system 21 comprises a switch (not shown) located within the vehicle which enables and disables the system 21.

The plurality of light sources 25 are located within the housing 23, as shown, and arranged to shine light outwards from the front of the vehicle. The plurality of light sources 25 comprise any of a plurality of LEDs, a plurality of lasers provided on a printed circuit board.

The light source optical system 27 comprises sixteen reflective mirrors 37, arranged in multiples of four reflective mirrors 100 mm long, in a substantially linear array. It will be appreciated that the light source optical system could instead comprise a plurality of optical lenses. Each reflective mirror 37 is placed in proximity to a subset of three light sources 25 and acts to shine light from one of the light sources 25 onto the roadway in front of the vehicle to illuminate a specified position of the roadway in front of the vehicle. Each of the subsets of three light sources 25 are arranged in a substantially linear array. The reflective mirrors 39 and light sources 25 together produce approximately 230 kcd.

The control circuit is connected to the plurality of light sources 25 and is configured to control selective operation of the light sources 25 to control brightness of each light source, or a subset of the light sources, independently.

The plurality of photosensing devices 29 are located within the housing 23, as shown, and configured to sense light shining towards the front of the vehicle and to produce a plurality of signals comprising light intensities from a plurality of positions in front of the vehicle. In this embodiment, the plurality of photosensing devices 29 comprise a plurality of photodiodes each having 1 mm2 sensing portion.

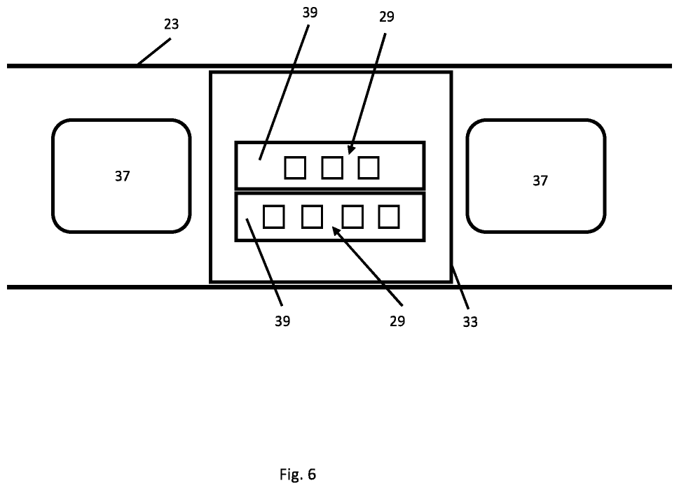

Referring to FIG. 6, the light sensor optical system 31 comprises two optical lenses 39 arranged one on top of the other, as shown. It will be appreciated that the light sensor optical system could instead comprise a plurality of optical reflectors. An upper optical lens 39 is placed in front of a subset of three photosensing devices 29, arranged in a substantially linear array, to direct light shining towards the front of the vehicle onto the photosensing devices 29. A lower optical lens 39 is placed in front of a subset of four photosensing devices 29, arranged in a substantially linear array, to direct light shining towards the front of the vehicle onto the photosensing devices 29.

The optical lenses 39 placed in front of the subsets of photosensing devices 29 are arranged in such a way to direct and focus light shining from a moving light source in front of the vehicle to illuminate successive photosensing devices 29. This causes successive photosensing devices 29 to register a higher than normal light intensity as the light source moves in front of the vehicle. As the light shining from the moving light source moves through a plurality of positions in front of the vehicle, only one photosensing device 29 will register a higher light intensity at each position.

The vehicle headlight system 21 operates in a high-beam mode and a low-beam mode. The controller is connected to the control circuit and the plurality of photosensing devices 29 and is configured to in the high-beam mode, send a signal to the control circuit to cause the control circuit to operate at least some of the plurality of light sources 25 at a high-beam brightness level, and in the low-beam mode, receive the plurality of signals indicating light intensities from a plurality of positions in front of the vehicle from the plurality of photosensing devices 29, use the signals to determine presence of an oncoming vehicle on the roadway and send a signal to the control circuit to cause the control circuit to operate one or more of the plurality of light sources 25 shining light towards the oncoming vehicle to reduce brightness of the one or more light sources to the low-beam brightness level or to zero.

The controller comprises an intelligent control algorithm which takes inputs from the plurality of photosensing devices 29 and determines the correct zones to illuminate on the roadway by the plurality of light sources 25.

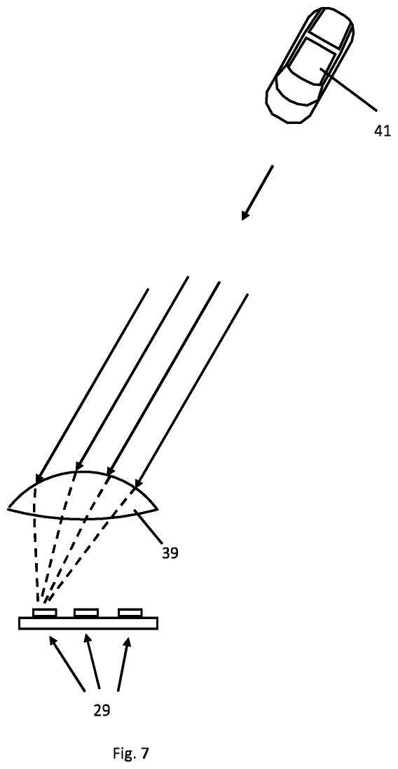

Referring to FIG. 7, light from a light zone produced by an oncoming vehicle 41 enters the optical lens 39 of the light sensor optical system at an angle which is dependent upon the position of the oncoming vehicle 41 on a roadway in front of the vehicle comprising the vehicle headlight system. As the oncoming vehicle 41 moves towards the vehicle, its position in front of the vehicle changes, i.e. over time, it takes up a plurality of positions in front of the vehicle.

On entering the low-beam mode, the controller sends a signal to the control circuit to cause the control circuit to operate at least some of the plurality of light sources 25 to reduce brightness of the light sources 25 to the low-beam brightness level. The low-beam brightness level may be approximately 30% of the high-beam brightness level.

The controller then waits for a pause period of time of approximately 100 ms. The controller then performs a self-calibration function to determine a baseline light intensity recorded by each of the plurality of photosensing devices 29. For each photosensing device 29, the self-calibration function comprises averaging light intensities of a plurality of signals received from the device 29 at spaced intervals to determine the baseline light intensity recorded by the photosensing device 29.

As the oncoming vehicle 41 moves towards the vehicle the light from the light zone produced by the oncoming vehicle 41 moves across the plurality of photosensing devices 29. The two optical lenses 39 of the light sensor optical system 31 and the plurality of photosensing devices 29 are arranged such that, one after the other, the light intensity of the signal from each photosensing device 29 is greater than the calibrated baseline light intensity of the device. Only one of the photosensing devices 29 records a greater intensity at a time, in FIG. 7, the leftmost photosensing device 29 of the subset of four photosensing devices 29 records a greater intensity.

For each photosensing device 29, the controller then compares the light intensity of at least one signal from the photosensing device 29 to the baseline light intensity of the device 29. When the light intensity of the at least one signal from a photosensing device 29 is greater than the baseline light intensity of the device 29, the controller determines that the photosensing device 29 is sensing a light zone of an oncoming vehicle in front of the vehicle.

The controller uses the signal from the photosensing device 29 to determine the identity of the photosensing device 29 and uses this to determine identities of a group of corresponding light sources 25 which shine light to the light zone of the oncoming vehicle 41. The controller then sends a signal to the control circuit to cause the control circuit to operate the group of corresponding light sources 25 shining light to the light zone of the oncoming vehicle 41 to reduce brightness of the group of corresponding light sources 25 to the low-beam brightness level or to zero. In this embodiment, the signal causes the control circuit to fast-dim the group of corresponding light sources 25. As the oncoming vehicle 41 moves towards the vehicle, successive groups of corresponding light sources 25 shining light to the light zone of the oncoming vehicle 41 are operated to reduce brightness.

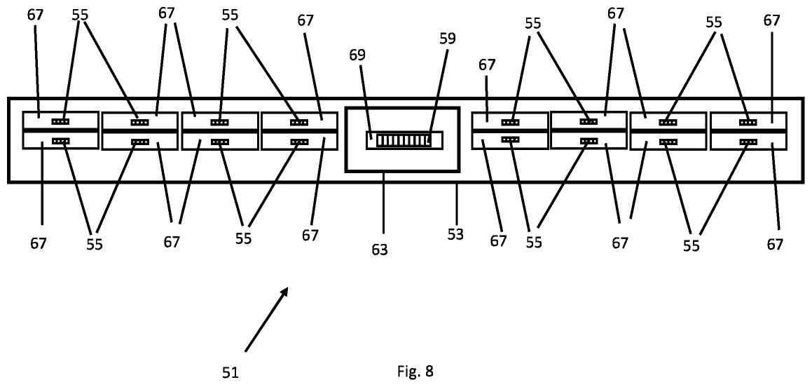

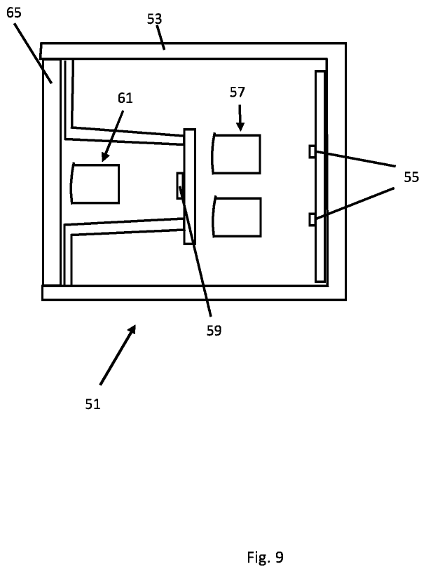

Referring to FIG. 8 and FIG. 9, a third embodiment of a vehicle headlight system 51 for a vehicle (not shown) comprises a housing 53, a plurality of light sources 55, a light source optical system 57, a control circuit (not shown), a plurality of photosensing devices 59, a light sensor optical system 61, a shield 63, a controller (not shown) and a cover 65.

The vehicle headlight system 51 may comprise a system installed in a vehicle on manufacture of the vehicle. The vehicle headlight system may be installed in a vehicle comprising any of a passenger car, a heavy goods vehicle, a light commercial vehicle. Alternatively, the vehicle headlight system 51 may comprise an auxiliary vehicle headlight system adapted for attachment to a vehicle after manufacture of the vehicle.

The housing 53 contains at least the plurality of light sources 55, the light source optical system 57, the plurality of photosensing devices 59, the light sensor optical system 61 and the shield 63. The housing 53 may further contain the control circuit and the controller, or these may be placed outside the housing 53. The housing 53 comprises a substantially transparent cover 65, which is an outer lens, located in front of the plurality of light sources 55 and the plurality of photosensing devices 59 to protect them from environmental conditions.

The plurality of photosensing devices 59 are located adjacent to and between a first left-hand light source and a second right-hand light source of the plurality of light sources 55, as shown. The shield 63, configured to reduce detection of light spill from the plurality of light sources 55 by the plurality of photosensing devices 59, is formed from housing for the photosensing devices 59. This acts as a barrier to reduce light from plurality of light sources 55 entering the photosensing devices 59.

The vehicle headlight system 51 comprises an electrical connection (not shown) connecting the system 51 to the vehicle by which power is supplied to the system 1 from the vehicle. The vehicle headlight system 51 comprises a switch (not shown) located within the vehicle which enables and disables the system 51.

The plurality of light sources 55 are located within the housing 53, as shown, and arranged to shine light outwards from the front of the vehicle. The plurality of light sources 55 comprises a plurality of LEDs.

The light source optical system 57 comprises twenty four aspheric lenses 67, arranged in pairs in a substantially linear array. It will be appreciated that the light source optical system could instead comprise a plurality of reflective mirrors. In each pair of lenses 67, the lenses are placed one on top of the other and each lens is placed in proximity to a subset of four light sources 55 and act to shine light from one of the light sources 55 onto the roadway in front of the vehicle to illuminate a specified position of the roadway in front of the vehicle. Each of the twenty four subsets of four light sources 55 are arranged in a substantially linear array.

The control circuit is connected to the plurality of light sources 55 and is configured to control selective operation of the light sources 55 to control brightness of each light source, or a subset of the light sources, independently.

The plurality of photosensing devices 59 are located within the housing 53, as shown, and configured to sense light shining towards the front of the vehicle and to produce a plurality of signals comprising light intensities from a plurality of positions in front of the vehicle. In this embodiment, the plurality of photosensors 59 comprise a plurality of photosensing cells of a silicon multiplier photosensor. There are ten photosensing cells of a silicon multiplier photosensor.

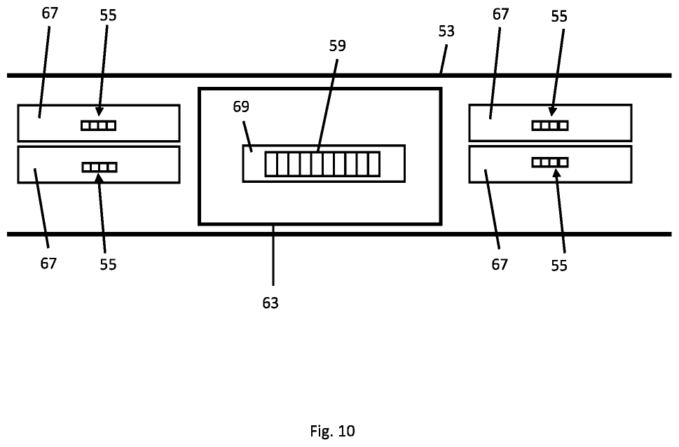

Referring to FIG. 10, the light sensor optical system 61 comprises one optical lens 69, placed in front of the photosensing devices 59, arranged in a substantially linear array, to direct light shining towards the front of the vehicle onto the photosensing devices 59.

The optical lens 69 placed in front of the photosensing devices 59 is arranged in such a way to direct and focus light shining from a moving light source in front of the vehicle to illuminate successive photosensing devices 59. This causes successive photosensing devices 59 to register a higher than normal light intensity as the light source moves in front of the vehicle. As the light shining from the moving light source moves through a plurality of positions in front of the vehicle, only one photosensing device 59 will register a higher light intensity at each position.

The vehicle headlight system 51 operates in a high-beam mode and a low-beam mode. The controller is connected to the control circuit and the plurality of photosensing devices 59 and is configured in the high-beam mode to send a signal to the control circuit to cause the control circuit to activate at least some of the plurality of light sources 55 to shine light at a high-beam brightness level, and in the low-beam mode, receive the plurality of signals indicating light intensities from a plurality of positions in front of the vehicle from the plurality of photosensing devices 59, use the signals to determine presence of an oncoming vehicle and send a signal to the control circuit to cause the control circuit to operate one or more of the plurality of light sources 55 shining light towards the oncoming vehicle to reduce brightness of the one or more light sources to the low-beam brightness level or to zero.

The controller comprises an intelligent control algorithm which takes inputs from the plurality of photosensing devices 59 and determines the correct zones to illuminate on the roadway by the plurality of light sources 55.

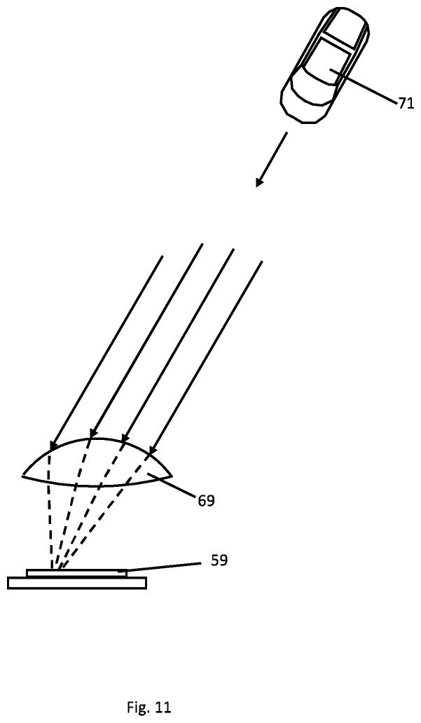

Referring to FIG. 11, light from a light zone produced by an oncoming vehicle 71 enters the optical lens 69 of the light sensor optical system at an angle which is dependent upon the position of the oncoming vehicle 71 on a roadway in front of the vehicle comprising the vehicle headlight system. As the oncoming vehicle 71 moves towards the vehicle, its position in front of the vehicle changes, i.e. over time, it takes up a plurality of positions in front of the vehicle.

On entering the low-beam mode, the controller sends a signal to the control circuit to cause the control circuit to operate at least some of the plurality of light sources 55 to reduce brightness of the light sources 55 to the low-beam brightness level. The low-beam brightness level may be approximately 30% of the high-beam brightness level.

The controller then waits for a pause period of time of approximately 100 ms. The controller then performs a self-calibration function to determine a baseline light intensity recorded by each of the plurality of photosensing devices 59. For each photosensing device 59, the self-calibration function comprises averaging light intensities of a plurality of signals received from the device 59 at spaced intervals to determine the baseline light intensity recorded by the photosensing device 59.

As the oncoming vehicle 71 moves towards the vehicle the light from the light zone produced by the oncoming vehicle 71 moves across the plurality of photosensing devices 59. The optical lens 69 of the light sensor optical system 61 and the plurality of photosensing devices 59 are arranged such that, one after the other, the light intensity of the signal from each photosensing device 59 is greater than the baseline light intensity. Only one of the photosensing devices 59 records a greater intensity at a time.

For each photosensing device 59, the controller then compares the light intensity of at least one signal from the photosensing device 59 to the baseline light intensity recorded by the device 59. When the light intensity of the at least one signal from a photosensing device 59 is greater than the baseline light intensity recorded by the device 59, the controller determines that the photosensing device 59 is sensing a light zone of an oncoming vehicle in front of the vehicle.

The controller uses the signal from the photosensing device 59 to determine the identity of the photosensing device 59 and uses this to determine identities of a group of corresponding light sources 55 which shine light to the light zone of the oncoming vehicle 71. The controller then sends a signal to the control circuit to cause the control circuit to operate the group of corresponding light sources 55 shining light to the light zone of the oncoming vehicle 71 to reduce brightness of the group of corresponding light sources 55 to the low-beam brightness level or to zero. In this embodiment, the signal causes the control circuit to fast-dim the group of corresponding light sources 55. As the oncoming vehicle 71 moves towards the vehicle, successive groups of corresponding light sources 55 shining light to the light zone of the oncoming vehicle 71 are operated to reduce brightness.

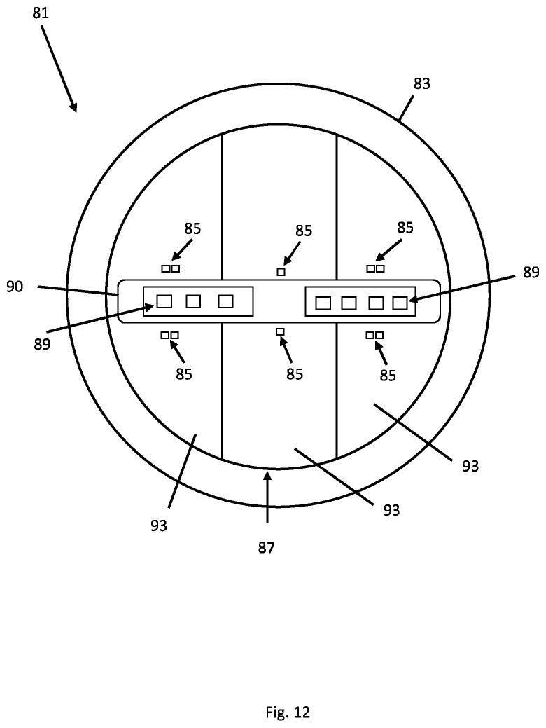

Referring to FIG. 12, a fourth embodiment of a vehicle headlight system 81 for a vehicle (not shown) comprises a housing 83, a plurality of light sources 85, a light source optical system 87, a control circuit (not shown), a plurality of photosensing devices 89, a light sensor optical system (not shown), a shield 90, a controller (not shown) and a cover (not shown).

The vehicle headlight system 81 may comprise a system installed in a vehicle on manufacture of the vehicle. The vehicle headlight system may be installed in a vehicle comprising any of a passenger car, a heavy goods vehicle, a light commercial vehicle. Alternatively, the vehicle headlight system 81 may comprise an auxiliary vehicle headlight system adapted for attachment to a vehicle after manufacture of the vehicle.

The housing 83 contains at least the plurality of light sources 85, the light source optical system 87, the plurality of photosensing devices 89, the light sensor optical system and the shield 90. The housing 83 may further contain the control circuit and the controller, or these may be placed outside the housing 83. The housing 83 comprises a substantially transparent cover, which is an outer lens, located in front of the plurality of light sources 85 and the plurality of photosensing devices 89 to protect them from environmental conditions.

The plurality of photosensing devices 89 are located adjacent to and between a first upper subset of the plurality of light sources 85 and a second lower subset of the plurality of light sources 85.

The vehicle headlight system 81 comprises an electrical connection (not shown) connecting the system 81 to the vehicle by which power is supplied to the system 1 from the vehicle. The vehicle headlight system 81 comprises a switch (not shown) located within the vehicle which enables and disables the system 81.

The plurality of light sources 85 are located within the housing 83, as shown, and arranged to shine light outwards from the front of the vehicle. The plurality of light sources 85 comprise a plurality of LEDs.

The light source optical system 87 comprises three reflective mirrors 93, arranged behind the plurality of light sources 85. It will be appreciated that the light source optical system could instead comprise a plurality of lenses. Each mirror 93 is placed in proximity to a subset of light sources 85 and acts to shine light from the subset of light sources 85 onto a roadway in front of the vehicle to illuminate a specified position of the roadway in front of the vehicle.

The control circuit is connected to the plurality of light sources 85 and is configured to control selective operation of the light sources 85 to reduce brightness of each light source, or a subset of the light sources, independently.

The plurality of photosensing devices 89 are located within the housing 83, as shown, and configured to sense light shining towards the front of the vehicle and to produce a plurality of signals comprising light intensities from a plurality of positions in front of the vehicle. In this embodiment, the plurality of photosensors 89 comprise a plurality of photodiodes.

The light sensor optical system comprises one optical lens, placed in front of the photosensing devices 89, arranged in a substantially linear array, to direct light shining towards the front of the vehicle onto the photosensing devices 89.

The optical lens placed in front of the photosensing devices 89 is arranged in such a way to direct and focus light shining from a moving light source in front of the vehicle to illuminate successive photosensing devices 89. This causes successive photosensing devices 89 to register a higher than normal light intensity as the light source moves in front of the vehicle. As the light shining from the moving light source moves through a plurality of positions in front of the vehicle, only one photosensing device 89 will register a higher light intensity at each position.

The vehicle headlight system 81 operates in a high-beam mode and a low-beam mode. The controller is connected to the control circuit and the plurality of photosensing devices 89 and is configured to in the high-beam mode, send a signal to the control circuit to cause the control circuit to operate at least some of the plurality of light sources 85 to shine light at a high-beam brightness level, and in the low-beam mode, receive the plurality of signals indicating light intensities from a plurality of positions in front of the vehicle from the plurality of photosensing devices 89, use the signals to determine presence of an oncoming vehicle and send a signal to the control circuit to cause the control circuit to operate one or more of the plurality of light sources 85 shining light to the oncoming vehicle to reduce brightness of the one or more light sources to the low-beam brightness level or to zero.

The controller comprises an intelligent control algorithm which takes inputs from the plurality of photosensing devices 89 and determines the correct zones to illuminate on the roadway by the plurality of light sources 85.

On entering the low-beam mode, the controller sends a signal to the control circuit to cause the control circuit to operate at least some of the plurality of light sources 85 to reduce brightness of the light sources 85 to the low-beam brightness level. The low-beam brightness level may be approximately 30% of the high-beam level.

The controller then waits for a pause period of time of approximately 100 ms. The controller then performs a self-calibration function to determine a baseline light intensity recorded by each of the plurality of photosensing devices 89. For each photosensing device 89, the self-calibration function comprises averaging light intensities of a plurality of signals received from the device 89 at spaced intervals to determine the baseline light intensity recorded the photosensing device 89.

As the oncoming vehicle moves towards the vehicle the light from the light zone produced by the oncoming vehicle moves across the plurality of photosensing devices 89. The optical lens of the light sensor optical system and the plurality of photosensing devices 89 are arranged such that, one after the other, the light intensity of the signal from each photosensing device 89 is greater than the baseline light intensity. Only one of the photosensing devices 89 records a greater intensity at a time.

For each photosensing device 89, the controller then compares the light intensity of at least one signal from the photosensing device 89 to the baseline light intensity recorded by the device 89. When the light intensity of the at least one signal from a photosensing device 89 is greater than the baseline light intensity recorded by the device 89, the controller determines that the photosensing device 89 is sensing a light zone of an oncoming vehicle in front of the vehicle.

The controller uses the signal from the photosensing device 89 to determine the identity of the photosensing device 89 and uses this to determine identities of a group of corresponding light sources 85 which shine light to the light zone of the oncoming vehicle. The controller then sends a signal to the control circuit to cause the control circuit to operate the group of corresponding light sources 85 shining light to the light zone of the oncoming vehicle to reduce brightness of the group of corresponding light sources 85 to the low-beam brightness level or to zero. In this embodiment, the signal causes the control circuit to fast-dim the group of corresponding light sources 85. As the oncoming vehicle moves towards the vehicle, successive groups of corresponding light sources 85 shining light to the light zone of the oncoming vehicle are operated to reduce brightness.

1-19. (canceled)

20. A vehicle headlight system for a vehicle operable in a high-beam mode and in a low-beam mode comprising:
a housing,
a plurality of light sources contained within the housing arranged to shine lightoutwards from a front of the vehicle,
a control circuit connected to the plurality of light sources and configured to control operation of the light sources in the high-beam mode and the low-beam mode,
a plurality of photosensing devices contained within the housing configured to sense light shining towards the front of the vehicle and to produce a plurality of signals indicating light intensities from a plurality of positions in front of the vehicle, the plurality of photosensing devices being located adjacent to at least some of the plurality of light sources,
a shield contained within the housing configured to reduce detection of light spill from the plurality of light sources by the plurality of photosensing devices, and
a controller connected to the control circuit and the plurality of photosensing devices and configured to:
in the high-beam mode, send a signal to the control circuit to cause the control circuit to operate at least some of the plurality of light sources to shine light at a high-beam brightness level, and
in the low-beam mode, receive the plurality of signals indicating light intensities from a plurality of positions in front of the vehicle, use the signals to determine an oncoming vehicle in one or more of the plurality of positions and send a signal to the control circuit to cause the control circuit to operate one or more of the plurality of light sources shining light to the oncoming vehicle to reduce brightness of the one or more light sources,
the headlight system including a light sensor optical system placed in front of the plurality of photosensing devices to direct light shining towards the front of the vehicle onto the plurality of photosensing devices, and
the light sensor optical system comprising a plurality of optical elements, wherein each optical element of the plurality of optical elements is placed in front of a respective subset of a plurality of subsets of the plurality of photosensing devices to direct light shining from a moving light source in front of the vehicle to illuminate successive photosensing devices of the subset of photosensing devices causing the successive photosensing devices to register a higher than normal light intensity as the light source moves in front of the vehicle.

21. The system according to claim 20 in which the control circuit may operate the one or more of the plurality of light sources shining light to the oncoming vehicle to reduce brightness of the one or more light sources to any of a low-beam brightness level or zero.

22. The system according to claim 20 further comprising a light source optical system placed in proximity to the plurality of light sources to shine light from the plurality of light sources onto a roadway in front of the vehicle.

23. The system according to claim 22 in which the light source optical system comprises an optical element placed in proximity to each of a plurality of subsets of the plurality of light sources to shine light from one light source of the subset of light sources onto the roadway in front of the vehicle to illuminate a specified position of the roadway in front of the vehicle.

24. The system according to claim 20 in which the plurality of photosensing devices comprises a plurality of photodiodes or a plurality of photosensing cells of a multi-cell photosensor.

25. The system according to claim 20 in which the shield configured to reduce detection of light spill from the plurality of light sources by the plurality of photosensing devices comprises a barrier placed between the plurality of light sources and the plurality of photosensing devices to reduce light spill from the plurality of light sources entering the plurality of photosensing devices.

26. The system according to claim 20 in which the shield configured to reduce detection of light spill from the plurality of light sources by the plurality of photosensing devices comprises software of the system which enables the plurality of photosensing devices to filter out light spill from the plurality of light sources.

27. The system according to claim 20 in which, for each of the plurality of photosensing devices, the controller uses one or more signals received from the photosensing device to perform a self-calibration function to determine a baseline light intensity recorded by the photosensing device.

28. The system according to claim 27 in which, for each photosensing device, the controller compares a light intensity of at least one signal from the photosensing device to the baseline light intensity recorded by the photosensing device and when the light intensity of the at least one signal is greater than the baseline light intensity, the controller determines that the photosensing device is sensing a light zone of an oncoming vehicle in front of the vehicle.

29. The system according to claim 28 in which the controller uses the signal from the photosensing device to determine the identity of the photosensing device and uses the identity of the photosensing device to determine identities of one or more corresponding light sources which shine light to the light zone of the oncoming vehicle in front of the vehicle.

30. The system according to claim 29 in which the controller sends a signal to the control circuit to cause the control circuit to operate the one or more corresponding light sources shining light to the light zone of the oncoming vehicle on the roadway in front of the vehicle to reduce brightness of the corresponding light sources.

31. A vehicle headlight system for a vehicle operable in a high-beam mode and in a low-beam mode comprising:
a housing,
a plurality of light sources contained within the housing arranged to shine light outwards from a front of the vehicle,
a control circuit connected to the plurality of light sources and configured to control operation of the light sources in the high-beam mode and the low-beam mode,
a plurality of photosensing devices contained within the housing configured to sense light shining towards the front of the vehicle and to produce a plurality of signals indicating light intensities from a plurality of positions in front of the vehicle, the plurality of photosensing devices being located adjacent to at least some of the plurality of light sources,
a shield contained within the housing configured to reduce detection of light spill from the plurality of light sources by the plurality of photosensing devices, and
a controller connected to the control circuit and the plurality of photosensing devices and configured to:
in the high-beam mode, send a signal to the control circuit to cause the control circuit to operate at least some of the plurality of light sources to shine light at a high-beam brightness level, and
in the low-beam mode, receive the plurality of signals indicating light intensities from a plurality of positions in front of the vehicle, use the signals to determine an oncoming vehicle in one or more of the plurality of positions and send a signal to the control circuit to cause the control circuit to operate one or more of the plurality of light sources shining light to the oncoming vehicle to reduce brightness of the one or more light sources,
wherein (a) for each of the plurality of photosensing devices, the controller uses one or more signals received from the photosensing device to perform a self-calibration function to determine a baseline light intensity recorded by the photosensing device and (b) for each photosensing device, the controller compares a light intensity of at least one signal from the photosensing device to the baseline light intensity recorded by the photosensing device and when the light intensity of the at least one signal is greater than the baseline light intensity, the controller determines that the photosensing device is sensing a light zone of an oncoming vehicle in front of the vehicle.

32. The system according to claim 31 in which the control circuit may operate the one or more of the plurality of light sources shining light to the oncoming vehicle to reduce brightness of the one or more light sources to any of a low beam brightness level or zero.

33. The system according to claim 31 further comprising a light source optical system placed in proximity to the plurality of light sources to shine light from the plurality of light sources onto a roadway in front of the vehicle.

34. The system according to claim 33 in which the light source optical system comprises an optical element placed in proximity to each of a plurality of subsets of the plurality of light sources to shine light from one light source of the subset of light sources onto the roadway in front of the vehicle to illuminate a specified position of the roadway in front of the vehicle.

35. The system according to claim 31 in which the plurality of photosensing devices comprises a plurality of photodiodes or a plurality of photosensing cells of a multi-cell photosensor.

36. The system according to claim 31 wherein the controller uses the signal from the photosensing device to determine the identity of the photosensing device and uses the identity of the photosensing device to determine identities of one or more corresponding light sources which shine light to the light zone of the oncoming vehicle in front of the vehicle.

37. The system according to claim 31 wherein the controller sends a signal to the control circuit to cause the control circuit to operate the one or more corresponding light sources shining light to the light zone of the oncoming vehicle on the roadway in front of the vehicle to reduce brightness of the corresponding light sources.

38. The system according to claim 31 in which the plurality of photosensing devices comprises a plurality of photodiodes or a plurality of photosensing cells of a multi-cell photosensor.
